(19) United States
(12) Patent Application Publication
(10) Pub. No.: US 2005/0156897 A1
(43) Pub. Date: Jul. 21, 2005

(54) Electronic device

(75) Inventor: Tatsuya Suzuki, Tokyo (JP)

Correspondence Address: HOGAN & HARTSON L.L.P., 500 S. GRAND AVENUE, SUITE 1900, LOS ANGELES, CA, 90071-2611, US

(73) Assignee: OLYMPUS CORPORATION

(21) Appl. No.: 11/061,142

(22) Filed: Feb. 18, 2005

Related U.S. Application Data
(63) Continuation of application No. PCT/JP04/18326, filed on Dec. 2, 2004.

(30) Foreign Application Priority Data
Dec. 3, 2003 (JP) P2003-405161

(51) Int. Cl. G09G 5/00

(52) U.S. Cl. 345/169

(57) ABSTRACT

An electronic device is provided with a grip portion for grasping the electronic device, and an operation section which can be operated by a user, and is made so that it is possible to lay said electronic device down with a one face thereof facing downwards; and the operation section is provided upon said one face, in a manner so as not to be operated by any object.

### PRIORITY CLAIM

This application is continuation application of a PCT Application No. PCT/JP2004/018326, filed Dec. 2, 2004, entitled “ELECTRONIC DEVICE” whose priority is claimed on Japanese Patent Application No. 2003-405161, filed Dec. 3, 2003. The content of both the PCT Application and Japanese Application is incorporated herein by reference.

### BACKGROUND OF THE INVENTION

1. Field of the Invention

The present invention relates to an electronic device which is operated by a user while being carried in his hand.

2. Description of Related Art

In an electronic device which is operated by a user while being held in his hand, such as an IC recorder, a PDA, a remote control device for a household electronic product such as a television, a video recorder, an air conditioner, a projector, or the like, or a portable telephone and the like, generally a lower surface of the electronic device is formed plane, and an operation section which includes buttons and/or a liquid crystal screen of the electronic device is disposed on an upper surface of the electronic device, in consideration of the fact that the electronic device may be placed on a flat surface, for example, a desk or the like (refer to FIG. 4 of Japanese Unexamined Patent Application, First Publication No. H09-35468).

For example, when a user wants to hold the above described electronic device which has been placed on a desk in his one hand for operating it, the user shall pick up the electronic device so that the upper surface on which the operation section is provided may face a palm of his one hand, and then, pass the electronic device from the one hand to the other so that the lower surface which has been in contact with the flat surface of the desk may face a palm of his other hand, and finally, he may operate the buttons or the like of the operation section with fingers of his one or other hand.

### SUMMARY OF THE INVENTION

An electronic device which is made so that the electronic device may be laid on an object with a predetermined surface of the electronic device facing downward comprising: a grip portion for a hand of a user to grasp the electronic device when it has been laid on the object; and an operation section which can be operated by a user without shifting the grip portion from one hand to the other; wherein the operation section is provided on the predetermined surface so as not to be operated by the object.

In the above electronic device of the present invention, it is preferable that a convex portion which comes into contact with the object is formed on the predetermined surface.

In the above electronic device of the present invention, it is preferable that the predetermined surface is formed in a concave so that the fingers of user's hand which has grasped the grip portion may be inserted between the electronic device and the object.

In the above electronic device of the present invention, it is preferable that a tapered surface which follows the fingers of user's hand which has grasped the grip portion is provided around the periphery of the predetermined surface, and the tapered surface is formed so as to make an acute angle with respect to the object.

### BRIEF DESCRIPTION OF THE DRAWINGS

FIG. 1 is a figure for explanation of the preferred embodiment of the present invention, and is a view showing a remote control device for a household electrical product from obliquely above, in the state of being oriented with a operation section facing upwards.

FIG. 2 is a view showing the same remote control device from obliquely above, in the state of being oriented with the operation section facing downwards.

FIG. 3 is a view showing the same remote control device from the side, in the state of being oriented with the operation section facing downwards.

FIG. 4 is a cross sectional view along the arrows IV-IV in FIG. 3, showing the same remote control device.

### DETAILED DESCRIPTION OF THE INVENTION

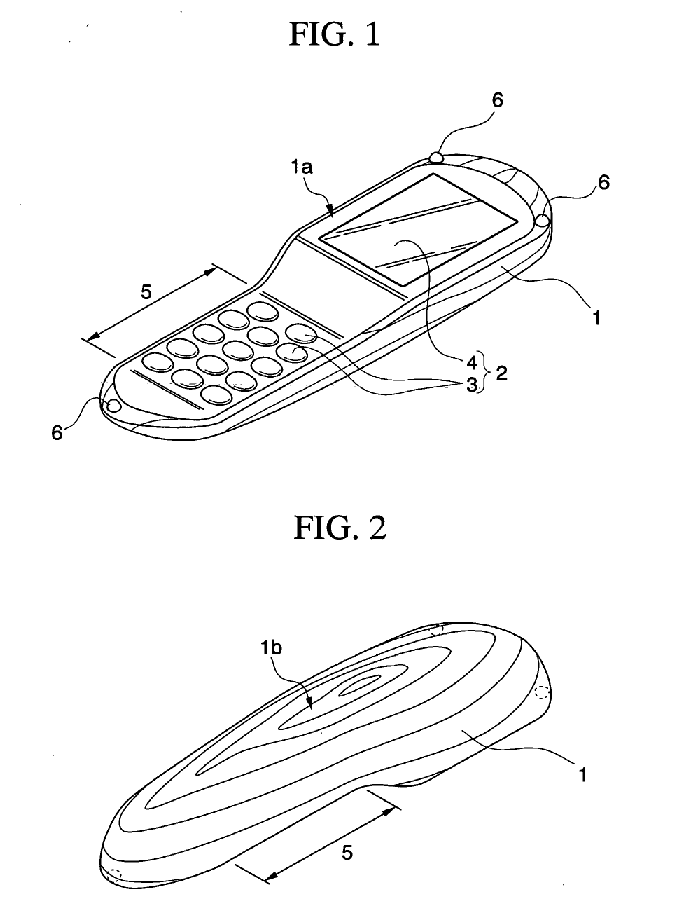

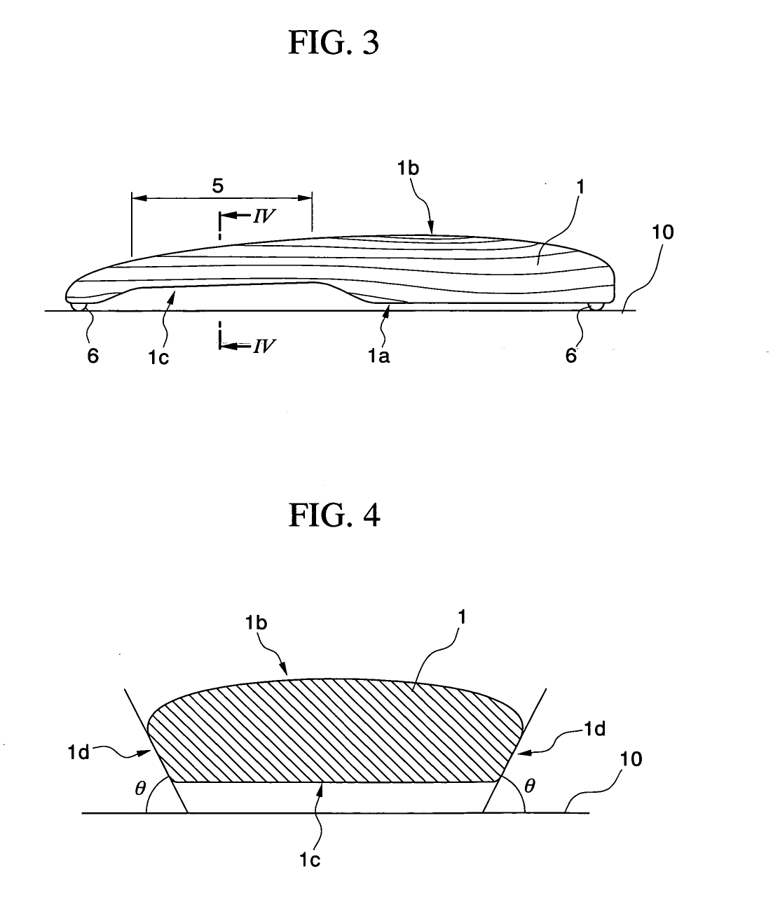

The first preferred embodiment of the present invention will now be explained with reference to FIG. 1 through FIG. 4.

In FIG. 1 through FIG. 3, as an example of an electronic device of the present invention, there is shown a remote control device for a television, a video recorder, an air conditioner, a projector or the like. This remote control device comprises a plurality of buttons 3 and a liquid crystal screen 4 which displays information for such operation as an operation section 2 for operating above household electrical product. A plurality of buttons 3 and the liquid crystal screen 4 are disposed on one face (predetermined surface) 1a of their elongated casing 1. A plurality of buttons 3 and the liquid crystal screen 4 are arranged so as not to project from the one face 1a, at such heights that they are almost coplanar with one another.

This remote control device can be typically placed on some object 10 (a desk or the like) with the one face 1a turned downward. And a grip portion 5 is provided upon the casing 1 in order for the user to grasp this remote control device which is lying with one face 1a down on object 10. This grip portion 5 is formed so that when, in the situation with this electronic device laid down with its one face 1a turned downward, the user contacts his palm against the other face 1b of the casing 1 which turns upward, then it is possible for him to insert and wrap his thumb from the one side of the casing 1 around said one face 1a thereof, while simultaneously inserting and wrapping his other four fingers from the opposite side of the casing 1 also around said one face 1a thereof.

Concretely, the girth of the casing 1 is made to be of such an order that, when the user has grasped the grip portion 5, all the fingers of his hand wrap around the one face 1a with a certain part left over. Therefore, it is possible for the user to operate the plurality of buttons 3 which constitute the operation section 2 without shifting the grip portion 5 from one hand to the other.

The one face 1a of the casing 1 is formed so as to define a smooth concave curved surface 1c, around the part on which the plurality of buttons 3 are provided. Furthermore, with the casing 1, a tapered surface 1d is provided around the periphery of the one face 1a, so that the fingers of a hand of a user who has grasped the grip portion 5 are made to follow around the one face 1a. This tapered surface 1d, as shown in FIG. 4, is formed so as to make a acute angle θ with the smooth surface of the object 10.

On the one face 1a of the casing 1, there are formed three convex portions 6 which are contact with the object 10. Two of the convex portions 6 are disposed on positions above the liquid crystal screen 4. One of the convex portions 6 is disposed on a position in the center below the buttons 3.

The casing 1 is formed of wood which has been strengthened by compression. It should be understood that, as the type for the wood, there may be suggested, for example, Japanese cypress, paulownia, teak, mahogany, cedar, pine, cherry, bamboo or the like. Furthermore it is possible to utilize, not only proper wood, but also a wooden substance like a material made by compressing waste wood chips or wood sawdust or the like. When this type of wood is compressed, the wood can be strengthened equal to aluminum.

In the remote control device as described above, when a user picks up the remote control device which has been laid down on the object 10 such as a desk or the like, and operates the operation section 2, the user grasps the grip portion 5 from above and lifts it up with one hand, and then turns around this hand while grasping the remote control device, without shifting the remote control device to his other hand. Thus, he is able to operate the plurality of buttons 3 on the operation section 2 with the fingers of his other hand, or with the fingers of the one hand, since the one face 1 a on which the operation section 2 is provided turns upwards.

According to the above remote control device, since the plurality of buttons 3 can be operated by fingers of the one hand which holds the remote control device or by fingers of the other hand, it is possible to operate the remote control device without any extra action of shifting the remote control device from one hand to the other.

Moreover, since the remote control device is to be laid down on the object 10 with the one face 1a oil which the operation section 2 is disposed downward, it is prevented from adhering of dust, dirt or the like to the plurality of buttons 3 and the liquid crystal screen 4.

Furthermore, since the convex portions 6 which are provided upon the one face 1a comes into contact with the object 10, the plurality of buttons 3 and the liquid crystal screen 4 do not come into contact with the object 10. Therefore, it is prevented from adhering of dust, dirt or the like to the plurality of buttons 3 and the liquid crystal screen 4. In addition, it is prevented from erroneous operating of the plurality of buttons 3.

Since the one face 1a on which the operation section 2 is provided is shaped as a concave, when the user grasps the grip portion 5, fingers of his hand are inserted between the grip portion 5 and the object 10 naturally, and his fingers touch the remote control device so as to wrap the grip portion 5 in his palm. Therefore, the remote control device can be held in his hand securely.

Furthermore, since the tapered surface 1d which is provided around the periphery of the surface 1a on which the operation section 2 is provided makes a acute angle θ with the object 10, when the user grasps the grip portion 5, fingers of his hand touch the tapered surface 1d naturally, and his fingers touch the remote control device so as to wrap the grip portion 5 in his palm. Therefore, the remote control device can be held in his hand securely in the same way as described above.

Moreover, the compressed wood which is used for the casing 1 is endowed with an excellent feeling which appeals to the human sense of touch, since it is excellent at absorbing moisture and is easily gripped in the hand. In addition, the compressed wood is endowed with high strength, and is excellent in durability and workability, so that it is suitable as a material for mass production. Therefore, it is very effective as a covering member for an electronic device.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

The electronic device of the present invention is not only suitable as a remote control device for a household electrical product as shown in the case of this preferred embodiment, but is suitable as any electronic device which is operated while being held in the hand of the user.

1. An electronic device which is made so that the electronic device may be laid on an object with a predetermined surface of the electronic device facing downward comprising:
a grip portion for a hand of a user to grasp the electronic device when it has been laid on the object; and
an operation section which can be operated by the user without the user shifting the grip portion from one hand to the other;
wherein the operation section is provided on the predetermined surface so as not to be operated by the object.

2. An electronic device according to claim 1, wherein a convex portion which comes into contact with the object is formed on the predetermined surface.

3. An electronic device according to claim 1, wherein the predetermined surface is formed in a concave so that the fingers of user's hand which has grasped the grip portion may be inserted between the electronic device and the object.

4. An electronic device according to claim 1, wherein a tapered surface which follows the fingers of user's hand which has grasped the grip portion is provided around the periphery of the predetermined surface, and the tapered surface is formed so as to make an acute angle with respect to the object.
